(19) United States
(12) Patent Application Publication
(10) Pub. No.: US 2005/0274170 A1
(43) Pub. Date: Dec. 15, 2005

(54) Integrated devices including microimpactor systems as particle collection modules

(76) Inventors: Alireza Shekarriz, Lake Oswego, OR (US); Mehdy Khatakhotan, Palo Alto, CA (US); Jeseph Gerard Birmingham, Vancouver, WA (US); Daniel James Faulkner, Portland, OR (US)

Correspondence Address: GARY C. COHN, PLLC, 1147 NORTH FOURTH STREET, UNIT 6E, PHILADELPHIA, PA, 19123, US

(21) Appl. No.: 11/086,488

(22) Filed: Mar. 22, 2005

Related U.S. Application Data
(60) Provisional application No. 60/555,159, filed on Mar. 22, 2004.

(51) Int. Cl. G01N 7/00; G01N 19/10; G01N 29/02; B01D 45/00

(52) U.S. Cl. 73/23.2; 55/434

(57) ABSTRACT

Integrated particle capture and detection devices include a microimpactor system for capturing particles or other materials from a fluid stream. The captured materials are subject to in situ analysis, inactivation or chemical reactions. The devices are particularly suitable as air purification devices or personal protection devices, where the air is possibly contaminated with pathogenic or toxic materials. The device can indicate the presence of these materials, or can be used to deactivate them and thus render the air safe for breathing.

### BACKGROUND OF THE INVENTION

This invention relates to apparatus and methods for separating particulate matter (solid particles and/or liquid droplets) from a fluid stream.

The increasing threat of biological and other weapons of mass destruction have created a need to provide effective, inexpensive and accurate detection devices. Because many of these weapons are easily portable (particularly biological agents), it is becoming increasingly necessary for airports and other transportation centers to be able to screen for the presence of these agents. In military, police and fire and emergency rescue situations, it is often necessary or at least beneficial to determine whether certain agents are present in the environment where personnel will be working, or whether personnel have been exposed to such agents. It is especially desirable that these detection devices be portable. Devices weighing less than one pound, especially devices weighing 4 ounces or less are particularly desirable.

Suitable detection devices typically include some kind of sample collection mechanism and a detector that interrogates the collected sample for identification and/or screening. Possible collection devices include various types of filters, cyclones, electrostatic precipitators, among other devices. For removing very small particulate matter, such as aerosol particles and microorganisms, from a gas stream, various types of virtual cyclones and virtual impactor devices have been devised. Examples of these are described in U.S. Pat. Nos. 6,156,212 and 6,386,015 (micromachined virtual impactor), U.S. Pat. No. 6,432,630 (micro-flow system using an external field to deflect particles), U.S. Pat. No. 6,270,558, U.S. Pat. No. 6,465,225 (centrifugal- or gravity-fed deflection system); U.S. Pat. No. 6,467,630 (column with applied “convective force”); and U.S. Pat. No. 6,062,392 (virtual impactor).

Preferred collectors operate simply and require minimal energy. In many devices, an efficient separation can be performed only if there is a high pressure drop through the device, or if some other energy (such as to create an external, particle-deflecting field) is applied. To address this problem, U.S. Pat. No. 6,110,247 describes a micropillar device which relies on an array of micropillar rows to capture particles from a fluid stream. The micropillar device provides separation of particulate matter at moderate pressure drops, while still allowing for recovery of the captured particulate matter. These devices generally require little energy to operate effectively.

In other cases, it is desirable to deactivate or conduct chemical reactions on air-borne particles and/or gasses. An example of such an application is in person protection devices, where a pathogen is desirable deactivated or converted to a harmless material on a real-time basis. Again, light-weight devices having low energy requirements are of interest.

### SUMMARY OF THE INVENTION

This invention is a detection device comprising a fluid conduit having a fluid inlet and a fluid outlet, a microimpactor system disposed within said fluid conduit and having a plurality of rows of microimpactors arranged in the fluid conduit substantially transverse to a main direction of flow of fluid through the fluid conduit, and at least one integrated analytical means for analyzing material captured by said microimpactors.

### DETAILED DESCRIPTION OF THE INVENTION

Microimpactor systems of the general designs described in U.S. Pat. No. 6,110,247 to Birmingham et al., the copending United States Patent Application of Faulkner et al., entitled “Microimpactor System for Collection of Particles From a Fluid Stream”, filed on even date herewith, and copending United States Patent Application of Birmingham et al., entitled “Microimpactor System Having Optimized Impactor Spacing”, also filed on even date herewith, are useful herein (all three incorporated herein by reference). In general, the microimpactor system includes a plurality of microimpactors arranged into a series of rows to form a two-dimensional array. The microimpactor system can be produced from a single piece of material, as described in U.S. Pat. No. 6,110,247, using, for example, micromachining or deep ion etching methods. Preferably, the microimpactor system is made using a sheet architecture approach described in the copending application of Birmingham et al. described above. In the sheet architecture approach, rows of microimpactors are defined by a series of openings in a sheet. Sheets are stacked, optionally with spacer devices, to create a two-dimensional array of microimpactors, wherein each microimpactor sheet defines one row of microimpactors within the array.

The microimpactors can be made in a variety of manufacturing process, which may depend somewhat on the material(s) of construction. Micromachining, photo-chemical etching, embossing, lithographic galvanic anodization (LIGA), lamination, injection molding, deep reactive ion etching (DRIE) and other fabrication methods can all be used. Of particular interest are photo-chemical etching and DRIE methods, as these can allow for rapid, inexpensive manufacture of microimpactor sheets with very good precision.

Inter-row spacing is advantageously from about 1 to about 20 times the microimpactor width, preferably about 3 to about 20 times the microimpactor width. Inter-row spacing may be between 3 and 10 times the microimpactor width and may be between 5 and 8 times the average microimpactor width. Intra-row spacing is also from about 3 to about 20 times the microimpactor width, and may also be between 3 and 10 times the microimpactor width or between 5 and 8 times the microimpactor width. Microimpactor widths are in general from about 1 to about 4,000 microns wide, preferably from about 10 to 400 microns wide, especially from about 10 to about 150 microns wide, more preferably from about 10 to about 100 microns wide. On an absolute basis, inter- and intra-row spacings of the microimpactors are both advantageously from about 3 to 10,000 microns, especially from about 20 to about 1000 microns, especially from about 30 to about 300 microns.

It is not necessary that the width of all microimpactors (either within a single sheet or within the array) be uniform, or that the spacing between them be uniform. If differing microimpactor widths are used, the inter- and intra-row spacing between microimpactors of differing widths is determined on the basis of the narrowest of such microimpactors.

The height of the microimpactors is generally not critical, and will typically be chosen to provide the desired cross-sectional area to the fluid conduit. Suitable microimpactor heights can range from about 1 micron to about 50 millimeters or more, and preferably from about 500 microns to about 15 millimeters and more preferably from about 1 to 10 millimeters. Microimpactors can be stacked within a fluid conduit if desired, to provide greater overall height and thus increase cross-sectional area.

Although the invention is illustrated with the microimpactors arranged in straight rows, this is not critical, and the microimpactors may assume a number of nonlinear configurations, including forming curved or even circular or elliptical rows. An embodiment of particular interest includes multiple micropillar rows that form a series of concentric circles, polygons, ellipses or other shapes. The direction of fluid flow in such an embodiment is either from the center of the concentric rows radially outward, or from the periphery of the concentric sheets radially inward.

The microimpactors can be made from a wide variety of materials, the choice of which may depend on the particular application in which they will be used. For example, the microimpactors may be made of a metal, a ceramic material, glass, thermoplastic or thermoset polymer, a rubber (synthetic or natural), a semiconductor material, or a combination of these materials. Different microimpactors in the array may be made of different materials. This may be desirable if, in the particular application, two or more different types of particles are to be removed from the fluid stream. The microimpactors may be substantially solid or may contain pores. Pores may be from the nano-scale up to 1 micron or more, of course depending somewhat on the dimensions of the microimpactor as a whole and the desired application.

Specific microimpactor materials of construction will of course be selected for specific applications. If the microimpactors are to be charged, the material of construction is conveniently a metal or other conductive material. In cases where the microimpactors are to be heated (such as to lyse or deactivate captured biological particles), the microimpactors are conveniently made from an electrical resistor that converts electrical energy to heat. The microimpactors may be made from a semiconductor such as silicon, and the semiconductor may include printed electrical circuitry that allows voltages to be applied to the microimpactors (for example, to apply a charge or generate heat), or electrical signals to be transmitted from the microimpactors for monitoring or analysis. The microimpactors may be a laminate or layered material.

In many applications, the microimpactors will function simply as a physical barrier to the movement of the particles through the microimpactor array, and as such the particular material of construction may not be especially important. However, there are many applications in which it is desirable that the microimpactors interact with the particles in some manner beyond presenting a simply physical barrier. In those instances, the composition of the microimpactors, or at least that of the surfaces of the microimpactors, are desirably prepared from a substance that will interact with the particles in the desired manner. To this end, the surfaces of the microimpactors may be treated or coated in various ways to promote the desired type of interaction between particle and microimpactor surface. Coatings such as this are preferably very thin, in the order of about 1 angstrom to 100 nm in thickness, so as not to significantly change the microimpactor dimensions.

Examples of interactions of this type include enhanced adhesion, decreased adhesion (for example, to facilitate cleaning), electrostatic attraction and/or repulsion, adsorption, deactivation, oxidation and/or reduction, lysing, catalysis, identification reactions, polymerization, other chemical reactions, analysis, and the like.

For example, the microimpactors may be coated with an adhesive so that the particles adhere better to the microimpactors and are more efficiently removed from the fluid stream. A wide range of adhesives is suitable. A particularly suitable type of adhesive is one that will release the particles when desired, such as by wetting, so the particles can be recovered and/or the microimpactor system cleaned. A particular adhesive that loses tack when wet is available from the Washington Technology Center, Seattle, Wash., under the trade name Tetraglyme™.

Alternatively, the microimpactors may be made from or coated with a non-stick material, such as a fluorinated polymer like Teflon™ fluoropolymer or Paralene™ polymer material (available from EM Corporation, Peachtree, Ga.) to enhance removal and/or recovery of the particles.

The microimpactors can be charged in order to electrostatically attract and bind the particles, and/or to deactivate or decompose the particles. In such a case, the microimpactors are advantageously made of, doped with or coated with a conductive or semiconductive material, which is in electrical connection to an electrical power source that supplies the necessary charge. An electrostatic attraction to the particles can be increased by applying an electrostatic charge to the particles themselves, at some point prior to passing the particle-laden stream through the microimpactor array. In such an embodiment, the particle-laden fluid is caused to flow through such a spray zone, and then into the microimpactor system, which is directly or indirectly in fluid communication with the spray zone. The spray zone includes a conduit for the particle-laden fluid and an apparatus for forming electrostatically charged droplets and spraying them into the fluid stream where they contact the particles. Atomizers of various types are known and are suitable. Examples of such sprayers include those described in U.S. Pat. Nos. 4,255,777, 4,439,980, 4,784,323, 5,062,573, 5,378,957, 6,227,465, 6,318,648 and WO 01/21319A1, all incorporated herein by reference. A particular preferred type of atomizer is described in U.S. Published patent application 2003/0071134A1, incorporated herein by reference. That atomizer includes (A) at least one microinjector including (1) an orifice through which the liquid is brought in contact with a pin emitter and (2) a conductive pin emitter extending outwardly from said orifice, the pin emitter having a radius of curvature in at least one location external to said orifice of no greater than 500 μm; B) means for introducing the liquid to be atomized through the orifice and to the pin emitter, and C) means for connecting said pin emitter to a voltage source. The liquid is preferably under a hydrodynamic pressure of 5 inches of H₂O or less.

Other materials of construction or coatings for the microimpactors include various types of materials that decompose and/or deactivate the particles, catalyze their decomposition and/or deactivation, catalyze some other reaction of the particles with themselves or other materials (including the microimpactors themselves), or else react directly with the particles. A wide range of such materials is possible, depending on the specific application. Deactivation and/or decomposition are particularly desirable in the case where the particles are pathogenic and/or toxic. In that case, the microimpactor surface can include, for example, a strong oxidant or reducing agent, or a toxin for the particles (in the case of a biological material). An example of such a deactivating agent is a platinum-on-alumina catalyst, which has been developed as an air purification catalyst for use against nerve agents. If the fluid sample is thought to contain multiple types of pathogenic and/or toxic agents, different microimpactors can be treated with different coatings, or made of different materials, each of which will deactivate and/or decompose a specific type of suspected pathogenic or toxic agent. Alternatively, different portions of individual microimpactors can be made of different materials for the same purpose.

Yet other materials of construction or coatings for the microimpactors include antibodies, ligands and membrane materials, which can perform, for example, enhanced particle capture, identification, inactivation, catalytic and/or reagent functions.

The microimpactor may be made of or include a piezoelectric material, if desired, so that controlled movement and/or physical distortion of the microimpactors can be caused through the application of an electrical current.

Microimpactors may be connected to electrical circuitry through various types of edge connector devices. Electrical circuitry includes, for example, connections to sources of electrical power and various kinds of detection and/or analytical devices.

Particles are removed from a fluid stream by flowing a particle-laden fluid through the fluid conduit in a main direction of flow transverse to the orientation of the microimpactors. The rows of microimpactors define a tortuous flow path through the fluid conduit, forcing the fluid (and particles) to change direction multiple times as it flows through the conduit. The particles have greater inertia than the fluid, due to their high mass (relative to that of the fluid molecules), and therefore tend to negotiate the changes in direction more poorly than the fluid. This causes the particles to impact and adhere to the microimpactors. In this manner, particles are removed from the fluid as it flows through the fluid conduit.

Captured particles often form extended “dentrite” structures by accumulating on the microimpactors in the form of “strings” of captured particles. This effect is often enhanced when an electrostatic charge is applied to the microimpactors (and optionally the particles to be captured). These dentrites extend from the surface of the microimpactors and often have the effect of increasing the ability of the microimpactors to capture more particles, thereby increasing the overall efficiency, with little or no corresponding increase in pressure drop.

Fluid flow through the microimpactor system may be provided by applying fluid pressure upstream of the system, by drawing a vacuum downstream of the system, or by ion wind generation (which may be effected by applying a charge to the microimpactor system). A variety of fans, micropumps and other devices may be used either upstream or downstream of the microimpactor system to effect the flow. These may be incorporated in fluid communication with the microimpactor system in a single device. For certain applications, such as personal protection devices, the requisite fluid flow can be produced through the inhalation or exhalation of an individual using the device. The microimpactor system can generally operate under relatively low pressure drops, such as <500 Pascals and especially less than about 100 Pascals, such as from about 10 to about 100 Pascals.

Fluid flow through the microimpactor system may also be achieved through movement of the microimpactor relative to the fluid, such as, for example by rotating the microimpactor system to obtain centrifugal movement of the fluid, or by moving the microimpactor system laterally through a fluid.

The microimpactor array can be designed to operate at a wide variety of flow rates, depending on application. However, because of the low pressure drop afforded by the microimpactor array, it is particularly of interest in applications involving low to moderate pressures across the device.

The efficiency of the particle removal, and the size and the size of the particles that are collected, are functions of various factors, including flow rates, microimpactor widths and spacing, spacing between rows of microimpactors, the mass of the particles, the mass of the fluid molecules, and the viscosity of the fluid (which may be negligible when the fluid is a gas, as is preferred), the surface properties of the microimpactors, the presence or absence of electrostatic charges, and other factors.

Although the invention is not limited to any theory, it is believed that the microimpactor system of the invention provides for improved particle capture due to the enhanced inter- and intra-row spacings. When the individual microimpactors are closely spaced, fluid flow accelerates in the narrow passages between microimpactors. Increasing the spacing causes less of this acceleration, at constant pressure drops across the device. The decreased acceleration is believed to have several beneficial effects. Because fluid flow rates are decreased, particles impact the front side (i.e., that facing the incoming fluid) of the microimpactors less violently, and are less prone to rebound back into the flowing fluid and be washed away. Lower acceleration also means that there is less turbulence within the fluid at the front surface of the microimpactors, which enables captured particles to remain in place better without being washed back into the fluid flow. In addition, the lower fluid accelerations create relatively quiescent zones downstream of the microimpactors. It is believed that a so-called “vortex shedding” phenomenon occurs in these regions. Particles entering these regions can be captured, even though these regions are downstream of the microimpactor, as the particles will tend to accumulate in regions of quiescent flow. Accordingly, particles are frequently seen to accumulate on the downstream surfaces of the microimpactors, and on the upstream surfaces as well. This leads to increased particle capture that compensates for the few number of microimpactors per unit area. In addition, the increased spacing allows the device to operate at lower pressure drops.

In this invention, a “fluid” is considered to be any material capable of fluid flow, including gasses, liquids, molten materials, and the like. The invention is particularly useful for removing particles from gasses, including air, nitrogen, oxygen, argon, helium, hydrogen, hydrocarbons, carbon dioxide, chlorocarbons, fluorocarbons, chlorofluorocarbons, various mixtures of gasses and the like.

“Particles”, in the context of this invention, include both solid particulate matter, as well as liquids that exist as discrete droplets within the fluid stream. To be separable, the particles need to have mass that is significantly greater than that of the molecules of the carrier fluid. The greater inertia of the particles causes them to change direction more slowly than the molecules of the carrier fluid. Particles having a longest dimension of from about 0.01-100 microns, especially from about 0.1 to about 100 microns, are particularly suitable for removal from a gaseous carrier fluid using this invention.

The composition of the particles is generally unimportant to the operation of the invention. The particles may include various types of biological matter such as bacterial spores, viruses, other microorganisms and pollen, and may include pathological agents such as anthrax or smallpox spores. The particles may include other chemical aerosols of all types, including those which have toxological properties. The particles may include inorganic or other organic particulate matter or droplets, such as water droplets, smog particles, smoke particles, dust particles, mineral particles, metal particles, and the like.

Captured particles and absorbed may be removed from the microimpactor array using various methods, such as the application of heat (to degrade, volatilize or combust the particles), by backwashing with a fluid flow in the reverse direction, flushing with solvents, removal or reversal of an applied electrostatic charge, various mechanical methods such as brushing, wiping, washing and the like, as well as other methods. Removed particles can be disposed of, taken for analysis, or used for various purposes as desired.

The microimpactor system of the invention can be used as a stand-alone device or combined with various other components to form an assembly that is adapted for specific applications. Examples of specific applications and devices that incorporate the microimpactor system are described below.

A. Particle Analysis and/or Detection. In these applications, captured particles are subject to one or more analytical techniques to determine physical, chemical and/or biological attributes, or to indicate the presence of certain types of particles or absorbed gasses. The device contains one or more integrated detection devices, such as those described below. Post-capture particle analysis or detection can be performed in-line and continuously, without the need to recover captured materials from the microimpactors.

The particular analytical or detection technique to be used will of course depend on the captured materials and the nature of the evaluation (or, the particular material whose presence is of interest). Collected particles may be removed from the microimpactor system if desired or necessary using techniques as set forth above.

For in-line particle analysis and detection, the microimpactor system and collected particles may be interrogated using a variety of sensing techniques, including visible and/or UV fluorescence, tetrahertz spectroscopy, Raman spectroscopy, IR spectroscopy, mass spectroscopy, MALDI-MS and the like. One or more detectors of these types are integrated into the device of the invention. Preferred devices contain two or more different detectors, in order to provide redundant or confirmatory testing to reduce false positive indications. In these applications, it is preferred that the microimpactors are transparent to the particular detecting device, or else distinguishable from the captured materials by that particular detecting device. The microimpactor may instead be made from or coated with various types of reagents, probes or biological materials such as ligands or antibodies, which engage in a chemical reaction or bond to specific types of materials and thereby indicate the presence of those materials in the fluid. In such cases, the detector device can interrogate the microimpactors themselves to indicate the presence of the captured material.

Thus, an analyzer according to an aspect of the invention includes one or more microimpactor systems, a fluid inlet and fluid outlet to the device in fluid communication with the microimpactor system, and at least one analytical device adapted to interrogate the microimpactor system for detection and/or analysis of captured materials. Such an analyzer may contain various optional but preferred features as have been described before with respect to other applications, including, for example, circuitry for powering and operating the analytical device and for obtaining data from the analytical device and converting it to human-readable form; various types of readouts and displays; means for creating a flow of the fluid through the microimpactor system; an optional prefilter or postfilter in fluid communication with the microimpactor system for removing particles that are not captured by the microimpactor system, an optional means to pre-sort incoming particles by size or to remove the bulk of the particles; and optionally means for accessing the microimpactor device for replacement, maintenance and/or cleaning. If desired, the entire analyzer can be mounted onto an integrated circuit board or other device, in order to integrate collection and detection/analysis. The analytical device can be of various types as described in the preceding paragraph.

Another detection device according to the invention is of similar design, except that in addition to the analytical device, reagents, probes or biological materials such as ligands or antibodies are present on the surface of the microimpactors to indicate the presence of specific types of particles in the fluid.

In another type of detector device, microimpactors are made from an optically transparent material such as quartz that is coated with a nuclear detection material (such as copper or nanoporous copper) that generates photons when it detects a particular material of interest. The microimpactor is connected to a fiber optic material that transmits the generated photon to a collector. The circuitry may include a filter, that allows only photons of a desired wavelength to pass (to remove noise or signals from species that are not of interest) and a photomultiplier to increase the signal.

One particular device of interest is a biological trigger device. The device includes a fluid conduit having a fluid inlet and fluid outlet, a microimpactor array arranged within the fluid conduit with the microimpactors transverse to the main direction of flow. The device further contains a light source that generates light of one or more specific wavelengths and directs the generated light at the microimpactors. In addition, the device contains or is connected to a detector that captures light emitted from materials that are captured on the microimpactors. The detector is typically either sensitive only to specific, characteristic wavelengths of emitted light, or else contains or is connected to a filtering apparatus that only allow signals corresponding to a desired wavelength of light to pass through. The device in addition preferably contains a human-readable display that indicates when light of the wavelength of interest is emitted from particles captured on the microimpactors.

The biological trigger device works by first capturing particles of a specific size range from a fluid, typically the air. The microimpactor system is advantageously designed to capture mainly particles representative of the biological material of interest. A failure to capture particles is a first indication that the biological material of interest is not present. Conversely, captured particles may represent the material of interest, and they are accordingly interrogated by exposing them to the light source. The light source emits radiation that causes specific constituents of particles (such as specific proteins or amino acids) of interest to fluoresce, and thereby emit light having a characteristic wavelength. In some cases, the interrogating radiation may in addition cause chemical reactions to occur that generate the particular species of interest. When this emitted light is detected, the presence of particular biological (or other materials) is indicated. A specific example of this is the detection of biological agents such as anthrax. Amino acids and/or proteins that are characteristic of specific biological agents often can be detected through their ability to fluoresce at specific wavelengths. An LED or laser that generates ultraviolet radiation at, for example ˜253 nm will cause proteins in anthrax spores to break down and generate their constituent amino acids (or fragments), often volatilizing them in the process. The amino acid then re-emits photons having a characteristic wavelength. An example of such an amino acid is tryptophan, which emits ˜276 nm ultraviolet light. The presence of light of the characteristic wavelength indicates the presence of the specific biological (or other) material.

In the biological trigger device, the microimpactors may act as both capture mechanism and part of the detector system. In such a case, the microimpactor is of an optically transparent material (at least for the wavelength of interest), and so is capable of conducting emitted photons to fiber optics and/or a detector. The detector is commonly a diode. The associated circuitry may include a photomultiplier tube to enhance the signal, and may also include one or more filters to remove signals associated with other wavelengths (such as background light and that generated by the light source).

B. Particle lysing, deactivation catalysis and chemical reactions. Materials captured by the microimpactor system can be subjected to a wide variety of operations, examples of which are lysing, deactivation, catalysis, and various chemical reactions such as oxidation or polymerization. This can be accomplished in several ways. The microimpactors themselves may be made from, be coated with or otherwise contain an agent that reacts with the captured particle to accomplish the desired operation. Alternatively, the particle-laden microimpactors may be exposed to an agent which accomplishes that operation. The microimpactors may also conduct electrical, electromagnetic or thermal energy to the captured particles for performing lysing, other electrochemical reactions or thermal degradation of captured particles.

A specific example of the foregoing is the deactivation of toxic chemical and biological agents and pathogens. In many military and civilian applications, it is necessary to protect individuals from ambient air-borne toxic materials and pathogens. Such toxic materials may include nerve agents, perfluorocarbons, other gaseous toxins, pathogenic microorganisms such as anthrax, smallpox or viruses, and the like. In such applications, a personal protection apparatus such as a breathing apparatus includes a microimpactor system in which the microimpactors are made from or coated with materials that react with, bind or otherwise deactivate specific types of air-borne toxins and pathogens. Thus, the microimpactor system serves not only to capture toxic and pathogenic particles, but also to render them into a non-hazardous or less hazardous form. A wide variety of deactivating materials can be used to make or coat the microimpactors, as described above. Combinations of different deactivating materials can be used to provide protection from mixtures of toxic agents and/or pathogens. For example, some microimpactors may be coated with a deactivating agent for one specific toxin or pathogen, whereas other are coated with a different deactivating agent for some other toxin or pathogen.

Alternatively or in addition, the microimpactors may be connected with a source of electrical energy, which allows the microimpactors to become electrostatically charged and lyse or inactive the toxic or pathogenic agent. The microimpactors may be combined with an energy source that heats the microimpactors and thermally lyses or inactivates the toxin or pathogen. The high surface area of the microimpactors allows excellent heat exchange with the captured particles and the fluid, allowing for very efficient thermal lysing and deactivation reactions to occur.

In another alternative, the microimpactor surface is made from or is coated with a catalyst that catalyzes a lysing or deactivation reaction between a toxin or pathogenic agent and some other reagent. The other reagent can be supplied together with or separately from the particle-laden fluid to perform the lysing or deactivation reaction on the captured particles.

A breathing device containing the microimpactor system as described can replace or supplement conventional gas mask technology. It is also scalable to collective protection applications such as shelters.

C. Non-particle capture applications. The microimpactor system is used in a variety of applications where a high surface area absorbent, reactive or catalytic surface is desired. The microimpactor system is particularly useful in low volume and/or in low pressure drop applications. Specific examples of such applications include:

1. Absorption. A microimpactor system having an absorbent surface effectively removes specific gasses from the fluid, through chemical affinity, electrostatic attraction or other attractive forces. As before, the microimpactors can be interrogated using various tools to detect the presence of such captured gasses, making the microimpactor system useful as a device for detecting the presence of those gasses in a fluid stream. If desired, the microimpactors may be in addition electrostatically charged and/or heated as described before to destroy or inactivate the specific gas. Further, the microimpactor containing the captured gas can be exposed to various types of chemical reagents that react with the captured gas to form a desired reaction product.

2. Catalytic oxidation. Personal protection devices for military and other applications often require that toxic gases be removed so air can be safely breathed. Certain nitrogen-containing toxic gases and agents are effectively destroyed by passing a mixture of them in an oxygen-containing atmosphere through a microimpactor system, in which the microimpactors are coated with a substance which catalyzes the thermal destruction of such compounds. A suitable such catalytic material is a platinum or palladium catalyst, which may be supported on a suitable support such as alumina. For a breathing apparatus that removes nitrogen-containing toxins and agents, catalysts that do not form NOₓ compounds are preferred. The microimpactor system is provided with a means to heat the microimpactors and/or the fluid conduit containing the microimpactors to a temperature at which the thermal decomposition of the toxic agent takes place. This can be accomplished, for example, by applying heat from an external flame (as would be suitable for use with small, lightweight personal protection apparatus useful in military applications, for example). Alternatively, the microimpactors may be made from an electrical resistor which generates heat when an electrical current is supplied.

Perfluorinated compounds can be catalytically destroyed in like manner, using a microimpactor system in which the microimpactors are coated with a suitable catalyst for the oxidation of such compounds.

Mixtures of toxic gases and agents can be effectively deactivated or destroyed in accordance with this invention. In one approach, this is accomplished by flowing a fluid containing the toxins through multiple microimpactor systems, arranged in series, in which each microimpactor system contains a catalytic coating that is specific for one of the toxins in the fluid. Alternatively, a single microimpactor system can be used, in which individual microimpactors within the microimpactor system are coated with the different catalysts.

3. Heat exchange. The high surface area of the microimpactor device makes it very useful as a device for removing heat from or transferring heat to a fluid. In this application, the microimpactors can be made of a thermally conductive material that allows them to efficiently transport heat away from or to the fluid. The microimpactors may be in thermal connection with an outside source of heat or cooling to augment its heat exchange function. In certain embodiments, the microimpactors are made of a resistor material, which converts an applied electrical voltage into heat for warming a fluid.

It will be appreciated that many modifications can be made to the invention as described herein without departing from the spirit thereof, the scope of which is defined by the appended claims.

1. A detection device comprising a fluid conduit having a fluid inlet and a fluid outlet, a microimpactor system disposed within said fluid conduit and having a plurality of rows of microimpactors arranged in the fluid conduit substantially transverse to a main direction of flow of fluid through the fluid conduit, and at least one integrated analytical means for analyzing material captured by said microimpactors.

2. The device of claim 1, wherein the analytical means is visible and/or UV fluorescence, tetrahertz spectroscopy, Raman spectroscopy, IR spectroscopy, mass spectroscopy or MALDI-MS.

3. The device of claim 2, wherein the device includes at least two different analytical means.

4. The device of claim 2, wherein the analytical means is adapted to detect the presence of a specific material captured by said microimpactors.

5. The device of claim 2, further comprising a human-readable display.

6. The detection device of claim 1, wherein said microimpactor system is adapted to capture particles in a size range of about 1-10 microns.

7. The detection device of claim 1, wherein said microimpactor system is adapted to absorb at least one gas from said fluid.

8. The detection device of claim 1, further comprising means to lyse or inactivate material captured by said microimpactors.

9. A device for capturing and inactivating or lysing pathogenic materials, comprising a fluid conduit having a fluid inlet and a fluid outlet, a microimpactor system comprising a fluid conduit having a plurality of rows of microimpactors arranged in the fluid conduit substantially transverse to a main direction of flow of fluid through the fluid conduit, and means for inactivating or lysing material captured by said microimpactors.

10. The device of claim 9, wherein the means for inactivating or lysing captured material provides heat for thermally degrading said material.

11. The device of claim 10, wherein at least some microimpactors are made of an electrically resistive material and generate heat for thermally degrading captured material when a voltage is applied to said microimpactors.

12. The device of claim 10, wherein at least some microimpactors are made of an electrically conductive material in electrical communication with an electrical power supply, and the captured material is inactivated or lysed by applying a voltage to said microimpactors.

13. The device of claim 9 wherein at least some microimpactors are made from or coated with a material that inactivates or lyses said captured material.

14. The device of claim 9, wherein the captured material is a biological agent.

15. The device of claim 9, which is an air purification device.

16. The device of claim 9, which is a personal protection device.

17. The device of claim 9, further comprising at least one integrated analytical means.

18. A method for capturing a material from a fluid stream and conducting a chemical reaction with the captured material, comprising (a) passing a fluid containing said materials through a microimpactor device under conditions such that at least a portion of said material is captured by the microimpactor device, and (b) conducting a chemical reaction on said captured material within the microimpactor device, wherein the microimpactor device includes a fluid conduit having a fluid inlet and a fluid outlet, and a microimpactor system comprising a fluid conduit having a plurality of rows of microimpactors arranged in the fluid conduit substantially transverse to a main direction of flow of fluid through the fluid conduit

19. The method of claim 18 wherein the chemical reaction is an oxidation reaction.

20. The method of claim 18 wherein said oxidation reaction is a catalytic oxidation reaction, and at least some microimpactors are made from or coated with a catalyst for such reaction.

21. The method of claim 21 wherein at least some microimpactors are made from or coated with a platinum or palladium catalyst.

22. The method of claim 18, wherein the material is a perfluorinated compound.

23. The method of claim 18, wherein the chemical reaction is a thermal decomposition or combustion reaction.

24. The method of claim 23, wherein at least some microimpactors are made of an electrically resistive material and generate heat for thermally decomposing or combusting said material when a voltage is applied to said microimpactors.

25. A biological trigger device comprising a fluid conduit having a fluid inlet and fluid outlet, a microimpactor array arranged within the fluid conduit with the microimpactors transverse to the main direction of flow, a light source that generates electromagnetic radiation of one or more specific wavelengths and directs the generated light at the microimpactors, and a detector for capturing electromagnetic radiation emitted from a material captured on the microimpactors.

26. The detector of claim 25, wherein the detector is sensitive only to specific, characteristic wavelengths of emitted radiation, or else contains or is connected to a filtering apparatus that only allows signals corresponding to a desired wavelength of electromagnetic radiation to pass through.

27. The device of claim 26, which further comprises a human-readable display that indicates when radiation of the wavelength of interest is emitted from materials captured on the microimpactors.

28. The device of claim 25, wherein the light source is an LED or laser that emits ultraviolet radiation of a characteristic wavelength.

29. The device of claim 28, wherein the characteristic wavelength is ˜253 nm.

30. The device of claim 25, wherein the detector is adapted to detect fluorescent light emitted by a captured material.

31. The device of claim 31, wherein the fluorescent light has a characteristic wavelength of ˜276 nm.

32. The device of claim 25, wherein the detector identifies the presence of tryptophan.
